(19) United States
(12) Patent Application Publication
(10) Pub. No.: US 2002/0028362 A1
(43) Pub. Date: Mar. 7, 2002

(54) Anode oxidation protection in a high-temperature fuel cell

(76) Inventors: Dennis Prediger, Calgary, CA (US); Debabrata Ghosh, Calgary, CA (US)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 09/682,427

(22) Filed: Aug. 31, 2001

Related U.S. Application Data
(60) Provisional application No. 60/229,332, filed on Sep. 1, 2000.

(51) Int. Cl. H01M 8/04; H01M 8/12; H01M 8/14

(52) U.S. Cl. 429/13; 429/23; 429/16; 429/30

(57) ABSTRACT

A method and apparatus for protecting the anode of a solid oxide or molten carbonate fuel cell from oxidation includes a controller having a voltmeter for monitoring the voltage output of the fuel cell and an external electric power source. If the fuel cell voltage output drops below a predetermined level, the controller causes the power source to be applied to the fuel cell which results in oxygen being transported away from the anode.

The present invention claims the benefit of U.S. Provisional Application No. 60/229,332 filed Sep. 1, 2000.

### BACKGROUND OF THE INVENTION

The invention relates to a control system to maintain the integrity of a high temperature fuel cell such as molten carbonate or solid oxide fuel cells in the event of a fuel loss or other condition which may lead to an oxidizing atmosphere in the anode.

The anode of a solid oxide fuel cell (SOFC) typically consists of a porous cermet made of nickel and yttria stabilized zirconia. The anode of a molten carbonate fuel cell (MCFC) typically consists of a porous nickel. In both cases, the nickel provides high electrical conductivity and strong catalytic capability. At normal MCFC or SOFC operating temperatures of 600° C. to 1000° C., the anode is subjected to a reducing atmosphere with a partial pressure of oxygen below the nickel nickel oxide equilibrium level. This allows the nickel metal to remain in a reduced state.

Under certain conditions, the partial pressure of oxygen can increase above the equilibrium nickel nickel oxide level. The subsequent formation of nickel oxide is catastrophic. The rapid oxidation of nickel to nickel oxide results in an increase in volume, which introduces large stresses in the anode structure, and can result in physical failure of the anode, the electrolyte, or both. After being converted to nickel oxide, the cell is unable to convert chemical energy into electrical energy efficiently and is considered a failed part. It is therefore essential to maintain a reducing atmosphere such that the partial pressure of oxygen is maintained below the nickel nickel oxide equilibrium level. Deviation above this limit is not acceptable, even for short periods of time, because at the operating temperatures of the SOFC the nickel oxidation reaction is very rapid.

The yttria stabilized zirconia comprising the SOFC electrolyte is an efficient oxygen ion conductor above 600° C. Normally, oxygen is conducted from the cathode electrode surface, through the electrolyte, to the anode electrode surface, where it reacts with hydrogen or carbon monoxide to form water or carbon dioxide. The difference in oxygen partial pressure across the electrolyte creates an electrochemical potential and the transfer of oxygen ions through the electrolyte results in an electrical current. Typical operating GTGlobal ThermoelectricPage: 2 voltages produced by a single SOFC cell may range from about 1.1 to about 0.6 volts. The open circuit voltage is directly related to the oxygen partial pressure across the electrolyte. The minimum operating voltage is therefore determined by the nickel nickel oxide equilibrium point. If the voltage drops below this level, nickel oxide forms.

A method of maintaining a reducing atmosphere to protect the anode is required in the event of a fuel loss, during shutdown, or during a standby condition. Currently, two strategies are employed to protect the anode. First, a small amount of fuel can continually be fed into the cell. This is acceptable if a source of fuel is available and the fuel economy penalty is acceptable. Alternatively, the SOFC can be sealed to prevent any oxidizing gas from entering the system. This latter strategy requires hermetic seals and valves, which is technically very difficult to achieve, requiring complex and expensive engineering.

Therefore, there is a need in the art for a method to prevent damage to the cell in the event of fuel loss, or other oxidizing condition by maintaining the partial pressure of oxygen below the equilibrium nickel nickel oxide level.

### SUMMARY OF INVENTION

The present invention is directed to a method and apparatus for monitoring the condition of the atmosphere in the anode of a molten carbonate or solid oxide fuel cell, and using the electrochemical properties of the cell and an appropriate control and feedback mechanism to effect change of the atmosphere inside the fuel cell. Although the invention will be described primarily with reference to a solid oxide fuel cell, it is intended that this invention include any high-temperature fuel cell having an anode which is subject to destructive oxidation during shut-down or fuel-loss events.

Accordingly, in one aspect, the invention comprises a method of maintaining a reducing atmosphere around an anode of a molten carbonate or solid oxide fuel cell, said method comprising the steps of: (a)monitoring the electrical potential generated by the fuel cell; and(b)applying an external electrical potential across the fuel cell, such that electric current flows through the cell in a direction opposite to current flow during normal operation of the fuel cell, whenever the voltage output of the cell drops below a predetermined level.

The fuel cell generated electrical potential is monitored by a controller comprising a voltmeter which is operatively connected to a switch and an electric power source for providing the external electrical potential to be applied across the cell. The source of the external electrical potential may comprise a battery, a fuel cell, a generator, a turbomachine or an electrical mains connection.

In one embodiment, the method further comprises the step of monitoring pressure in an incoming fuel line and applying an external electrical potential across the fuel cell, such that electric current flows in through the cell in a direction opposite to current flow during normal operation of the fuel cell, whenever the fuel pressure drops below a predetermined level.

In another aspect, the invention comprises a high-temperature fuel cell such as a molten carbonate or solid oxide fuel cell comprising:(a)means for monitoring the electrical potential generated by the cell; (b)an electric power source; and(c)means for applying the power source to the cell whenever the electrical potential generated by the cell drops below a predetermined level, such that electric current flows through the cell in a direction opposite to current flow during normal operation of the fuel cell, said power application means operatively connected to the monitoring means.

The monitoring means may comprise a voltmeter and the power application means may comprise a disconnect box for switching the cell output power and switching the electric power source. A controller may incorporate the monitoring means and control the disconnect box. In one embodiment, the fuel cell further comprises means for monitoring pressure in an incoming fuel line, operatively connected to the means for applying a power source, wherein said pressure monitoring means activates the power application means when the pressure in the fuel line drops below a predetermined level.

In another aspect, the invention may comprise a molten carbonate or solid oxide fuel cell comprising: (a)a controller comprising a voltmeter for monitoring the voltage output of the fuel cell;(b)an external electric power source which, when applied to the fuel cell, causes current to flow through the fuel in a direction opposite to normal direction of current during normal operation of the fuel cell;(c)a disconnect box comprising a first switch for disconnecting the fuel cell from its external circuit and a second switch for applying the external power source to the fuel cell;(d)wherein said controller is operatively connected to the disconnect box to disconnect the first switch and/or apply the second switch whenever the voltage output of the fuel cell drops below a predetermined level.

In one embodiment, the fuel cell may further comprise a pressure gauge connected to a fuel input line and operatively connected to the controller, such that the disconnect box is activated when fuel pressure drops below a predetermined level.

### BRIEF DESCRIPTION OF DRAWINGS

The invention will now be described by way of an exemplary embodiment with reference to the accompanying drawings. In the drawings:

FIG. 1 shows a schematic representation of an embodiment of an apparatus of the present invention.

FIG. 1A shows a schematic representation of current flow during normal operation and during anode protection mode through a SOFC.

FIG. 2 shows a schematic representation of a controller of one embodiment of the invention. FIG. 3 shows a graphical representation of the effects on voltage and current when the fuel supply is cut off to a fuel cell and the present invention is used to protect the anode.

FIG. 4 shows a graphical representation of voltage and current supplied to a fuel cell when fuel is cut off and the fuel cell is allowed to cool down.

### DETAILED DESCRIPTION

The present invention provides for a method and apparatus for protecting the metallic component of a SOFC anode from oxidation. When describing the present invention, the following terms have the following meanings, unless indicated otherwise. All terms not defined herein have their common art-recognized meanings.

The term “anode” refers to the electrode of a fuel cell that the oxygen ions migrate to where they react with the fuel gas electrochemically and release electrons.

The term “nickel-nickel oxide equilibrium level” refers to the specific conditions at which nickel metal is oxidized to nickel oxide in an oxidizing atmosphere. The equilibrium level is dependent upon the temperature and the partial pressure of oxygen surrounding the nickel. The voltage necessary to maintain the nickel in a reduced state is determined from the following thermodynamic equation:

E=Eo−IR In

Where:

E is the required voltage

Eo is the thermodynamic voltage of the Ni NiO reaction

I is the current

R is the total ohmic resistance

n is the polarization overpotential

The object of the present invention is to maintain the metallic component of a SOFC anode in a reduced state. The present description refers to nickel as the metallic component, however, one skilled in the art will understand that the present invention may be applied equally to any anode having a metallic component which must be maintained in a reduced state for efficient fuel cell operation.

The present invention utilizes the electrochemical properties of the SOFC membrane to remove oxygen from the vicinity of the anode, thus maintaining the partial pressure of oxygen below the nickel nickel oxide equilibrium level, thus keeping the nickel reduced. In effect, the anode is made to act like a cathode, ionizing oxygen by the addition of electrons and transporting the oxygen ions through the electrolyte membrane to the cathode. Furthermore, the present invention uses the SOFC membrane as a sensor to monitor the atmosphere in the vicinity of the anode.

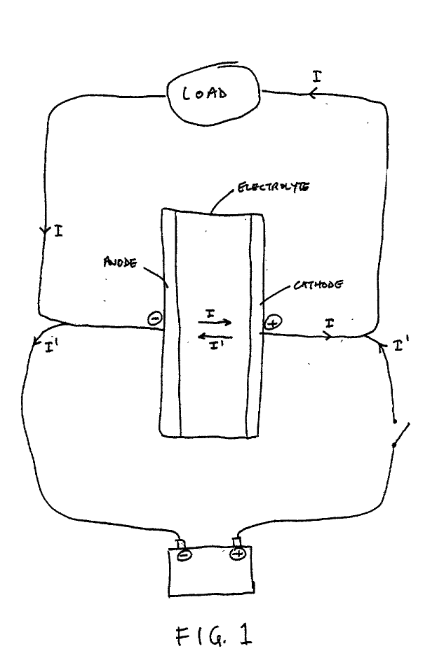

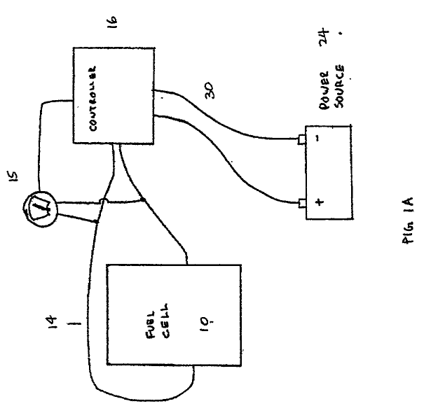

As shown in FIG. 1, in normal operation, oxygen is ionized at the cathode and transported across the electrolyte to the anode where the oxygen combines with a fuel gas and which releases electrons at the anode. The electrons flow through an external circuit, powering an electrical load, and returning to the cathode side. Thus, electric current (I) flows as shown in FIG. 1. Under open circuit conditions, if an oxidizing atmosphere is present in the anode, the voltage produced by the cell will drop, as indicated by a voltmeter (15). An external power supply may then be switched to supply current (I′) to the cell (10) in the opposite direction as normal current (I). Any oxygen around the anode will be ionized and transported through the electrolyte to the cathode as a result of the reverse current (I′).

The partial pressure of oxygen is lowered in the atmosphere surrounding the anode by maintaining a voltage above an acceptable level. In a normal operating state, a steady flow of fuel is directed at the anode and the fuel is oxidized by oxygen ions which have been transported across the electrolyte from the cathode. The oxidation of fuel releases electrons which travel through an external circuit to the cathode to produce electric power. If the voltage produced by the cell drops under open circuit conditions, that is an indicator that the partial pressure of oxygen in the anode has risen. If the voltage drops below a pre-determined level, which is chosen to correlate to the nickel nickel oxide equilibrium, then an electrical current is externally applied to the fuel cell membrane opposite to the normal flow. This action draws oxygen from the anode electrode surface and transports it through the electrolyte to the cathode.

Any oxygen entering the vicinity of the anode is removed in this manner.

When the cell is operating with an external load, current is drawn from the cell and the voltage drops, as a result of the current draw. The current is allowed to increase, along with the corresponding voltage drop, until a predetermined point. If the demand for current is still increasing beyond the cell's capability to supply it, then the voltage would drop further into the danger zone. In order to preserve the cell, load is shed at this point to try and reduce the current drawn from the cell. If these measures are not successful is raising the voltage of the cell out of the danger zone, even when all the load is removed, than an external voltage is applied and the current flow will be reversed from the state of normal operation. The voltage will be applied to maintain the cell's voltage above the critical level, and the cell will be allowed to draw as much current as necessary to maintain the required voltage. At no time will the cell be drawing current from the external source and generating current itself.

In a simple embodiment, an apparatus of the present invention is shown schematically in FIG. 1A. An external power source (24) is connected to the fuel cell (10) through a controller (16) which acts to switch the power to the cell on or off. A voltmeter (15) reads the output voltage of the cell (10). In one embodiment, the controller has as an input the output voltage. If the output voltage is lower than a predetermined level, which correlates to the nickel-nickel oxide equilibrium point, then the controller reduces the load, and when this is zero, applies external current to the cell on an as needed basis.

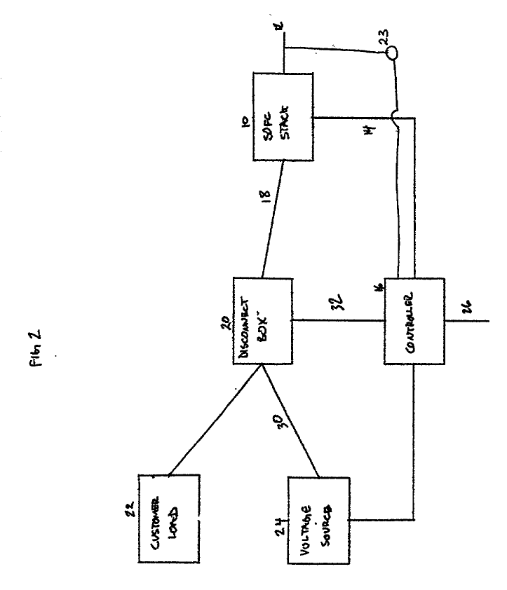

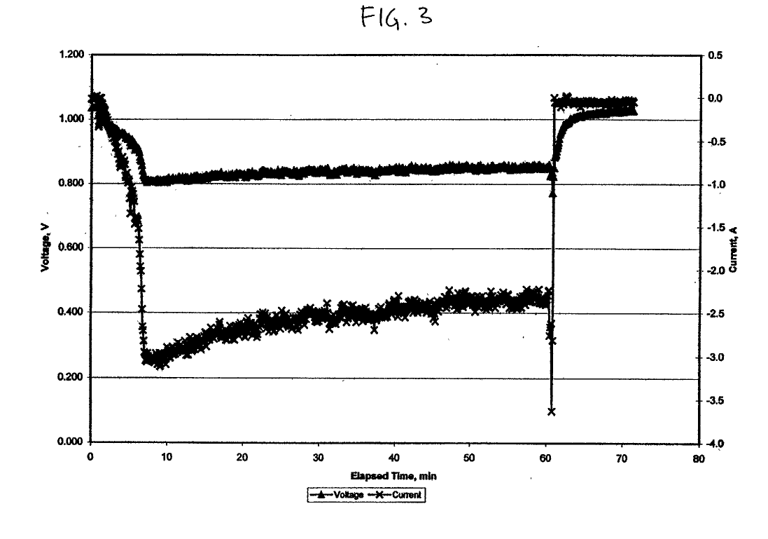

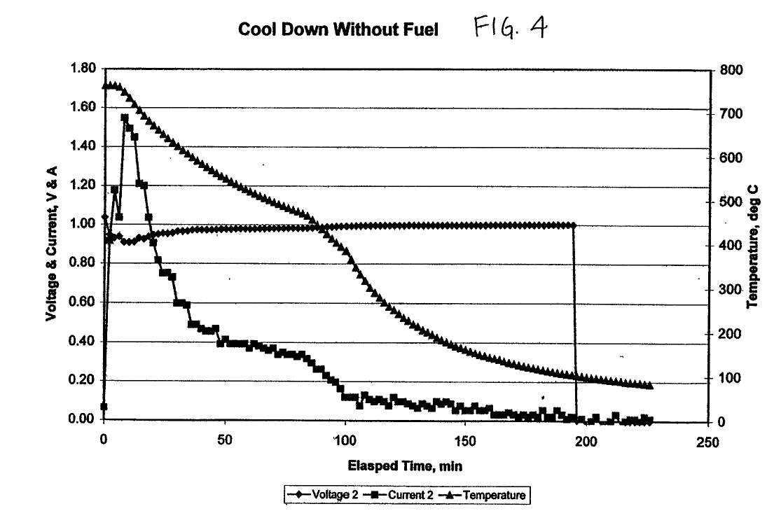

In another embodiment of the invention as depicted in FIG. 2, a solid oxide fuel cell (10) receives a fuel stream (12) and an oxidant stream (not shown). The output voltage of the cell (14) is fed into the controller (16) for comparison with the reference voltage below which damage to the anode of the cell (14) may result. Voltage (14) is a reference voltage used by the controller to determine the oxidation state of the anode, while voltage (18) is the main power output of the cell (10), and handles the current output of the cell to the customer load (22). The output power of the cell (18) is fed into the disconnect box (20). The disconnect box (20) consists of an arrangement of diodes, relays, and other electronic devices that provide the disconnect box (20) with the ability to switch the power routing from the cell (10) to the customer load (22) where the power will do useful work. The customer load (22) can be any device that uses DC power, such as an electric motor, or may be a rectifier for those devices that require AC. The output voltage and current can be modified by filters, transformers or other known processing devices.

Means for monitoring the fuel input system may be used to directly indicate fuel flow or loss of fuel flow to the fuel cell. For example, a pressure gauge (23) may be attached to the fuel input lines (12) to instantly detect loss of fuel pressure. The pressure gauge may also be operatively connected to the controller. In the event the pressure gauge senses a loss of pressure, indicating loss of fuel, the controller will act on the disconnect box to shed the customer load, and apply external power to the cell if the cell's voltage does not rise. The pressure gauge (23) provides a faster mechanism for activating the external power than the voltmeter.

The disconnect box (20) can also switch the power routing from an external power source (24) back to the cell (10). The power would be routed back to the cell (10) in the event of shut down, fuel loss, other oxidizing condition in the anode of the cell (10) as sensed by a reduction of the output voltage of the cell (14) or loss of fuel pressure or both. The transition point for switching from drawing power from the cell, to dropping load and applying external power to the cell is generally 0.65V when the cell is loaded, but this is dependant upon the specific composition, temperature, and type of the anode of the cell.

The construction of the disconnect box (20) will be apparent to one skilled in the art, in light of the within description of its function.

The controller (16) can be a computer program, PLC controller, or other suitable logic device. The controller takes as input the output voltage of the fuel cell (14) and compares it to the predetermined reference level. If the output voltage is in the safe region, the controller (16) allows power (18) to be drawn from the cell and directs it through the disconnect box (20) to the customer load (22). If the output voltage (18) is in the danger area, the controller directs the customer load (22) to be reduced in an attempt to restore the voltage to the safe region. If a total reduction of the customer load (22) to zero is not successful in restoring the voltage to a safe level, then power (30) is applied to the cell from the external power source (24).

The reference level of the output voltage of the cell (18) is the critical level of the nickel nickel oxide equilibrium. This reference voltage is used by the controller (16) to determine the appropriate direction of power flow to or from the cell (10). Maintaining the voltage (18) above this critical level will drive the reaction to absorb any free oxygen from the anode of the cell and move it to the cathode, where it will cause no harm to the cell. Once the external power (30) is applied, the voltage will be regulated by the controller (16) but the cell will be allowed to draw as much current as necessary.

In another embodiment, the control system can be overridden or replaced and manually operated by an operator monitoring the cells output voltage (18) and modifying the customer load (22) and applying the external power source (30) to the cell when the voltage is dropping toward the critical level, and then again disconnecting the power source and increasing the customer load when the cell is producing power and the danger of crossing the nickel nickel oxide equilibrium threshold is past.

In the case of shut down mode, once the customer load is removed and the cell is open circuited, external power is applied until the cell is cool, and the danger of crossing over the nickel nickel oxide equilibrium is over. In a startup mode, as fuel is introduced to bring the cell back into service, the externally applied power (30) is reduced until it is shut off when the cell is producing power.

1. A method of maintaining a reducing atmosphere around an anode of a molten carbonate or solid oxide fuel cell, said method comprising the steps of:
(a)monitoring the electrical potential generated by the fuel cell; and
(b)applying an external electrical potential across the fuel cell, such that electric current flows through the cell in a direction opposite to current flow during normal operation of the fuel cell, whenever the voltage output of the cell drops below a predetermined level.

2. The method of claim 1 wherein the fuel cell generated electrical potential is monitored by a controller comprising a voltmeter which is operatively connected to a switch and an electric power source for providing the external electrical potential to be applied across the cell.

3. The method of claim 1 wherein the source of the external electrical potential comprises a battery, a fuel cell, a generator, a turbomachine or an electrical mains connection.

4. The method of claim 2 wherein the controller maintains the electrical potential supplied to the cell at a predetermined level and the amount of current supplied to the cell is allowed to vary.

5. The method of claim 1 further comprising the step of monitoring pressure in an incoming fuel line and applying an external electrical potential across the fuel cell, such that electric current flows in through the cell in a direction opposite to current flow during normal operation of the fuel cell, whenever the fuel pressure drops below a predetermined level.

6. The method of claim 2 wherein the fuel cell is connected to an external load and further comprising the step of reducing or eliminating the external load prior to switching to the external power source.

7. A molten carbonate or solid oxide fuel cell comprising:
(a)means for monitoring the electrical potential generated by the cell;
(b)an electric power source; and
(c)means for applying the power source to the cell whenever the electrical potential generated by the cell drops below a predetermined level, such that electric current flows through the cell in a direction opposite to current flow during normal operation of the fuel cell, said power application means operatively connected to the monitoring means.

8. The fuel cell of claim 7 wherein the monitoring means comprises a voltmeter and the power application means comprises a disconnect box for switching the cell output power and switching the electric power source.

9. The fuel cell of claim 8 further comprising a controller which incorporates the monitoring means and which controls the disconnect box.

10. The fuel cell of claim 7 further comprising means for monitoring pressure in an incoming fuel line, operatively connected to the means for applying a power source, wherein said pressure monitoring means activates the power application means when the pressure in the fuel line drops below a predetermined level.

11. The fuel cell of claim 7 wherein the electric power source comprises a galvanic cell.

12. The fuel cell of claim 11 wherein the galvanic cell is a battery.

13. The fuel cell of claim 12 wherein the galvanic cell is another fuel cell.

14. The fuel cell of claim 8 wherein said disconnect box comprises means for reducing or eliminating external load on the fuel cell in response to the controller.

15. The fuel cell of claim 7 wherein the means for applying the power source is a switch which is responsive to the level of the electrical potential generated by the cell, as measured by the monitoring means.

16. A molten carbonate or solid oxide fuel cell comprising:
(a)a controller comprising a voltmeter for monitoring the voltage output of the fuel cell;
(b)an external electric power source which, when applied to the fuel cell, causes current to flow through the fuel in a direction opposite to normal direction of current during normal operation of the fuel cell;
(c)a disconnect box comprising a first switch for disconnecting the fuel cell from its external circuit and a second switch for applying the external power source to the fuel cell;
(d)wherein said controller is operatively connected to the disconnect box to disconnect the first switch and/or apply the second switch whenever the voltage output of the fuel cell drops below a predetermined level.

17. The fuel cell of claim 16 further comprising a pressure gauge connected to a fuel input line and operatively connected to the controller, such that the disconnect box is activated when fuel pressure drops below a predetermined level.
